(19) United States
(12) Patent Application Publication
(10) Pub. No.: US 2011/0295584 A1
(43) Pub. Date: Dec. 1, 2011

(54) VERIFICATION SUPPORT PROGRAM, LOGIC VERIFICATION DEVICE, AND VERIFICATION SUPPORT METHOD

(75) Inventor: Junichiro WATANABE, Kawasaki (JP)

(73) Assignee: FUJITSU LIMITED, Kawasaki-shi (JP)

(21) Appl. No.: 13/086,088

(22) Filed: Apr. 13, 2011

(30) Foreign Application Priority Data
May 28, 2010 (JP) 2010-123343

(51) Int. Cl. G06F 17/50

(52) U.S. Cl. 703/15

(57) ABSTRACT

A computer-readable recording medium configured to store a verification support program, the program causing a computer to execute logic verification operations for a system including a plurality of control circuits, and a plurality of hardware units that correspond to the control circuits. The logic verification operations are executed using a verification model of the system. The verification model includes a control circuit model which has a function of the control circuit, and a plurality of hardware models which have functions of the plurality of hardware units. The logic verification operations include accepting instructions from the plurality of hardware models by the control circuit model; selecting an instruction to be processed by one of the plurality of hardware models from the accepted instructions by the control circuit model; and reporting a processing request of the selected instruction to the plurality of hardware models by the control circuit model.

### CROSS-REFERENCE TO RELATED APPLICATIONS

This application is based upon and claims the benefit of priority of the prior Japanese Patent Application No. 2010-123343 filed on May 28, 2010, the entire contents of which are incorporated herein by reference.

### FIELD

Embodiments discussed herein relate to a verification support program, a logic verification device, and verification support method for supporting logic verification for a verification target circuit.

### BACKGROUND

Generally, in logic verification for a large server system with symmetric multiple processor (SMP) configuration, a mere part of a system is regarded as a verification target, and a verification model corresponding to the verification target is created to reduce an amount of circuits built on a simulator. For example, some system boards are regarded as verification targets from among multiple system boards in a system and a verification model of the verification targets is created. In addition, in the related arts to create a verification model in a large server system, there have been proposed technologies which reduce an amount of circuits by designing some system boards with a behavioral model described at a behavior level and increasing the abstraction level of the model.

For example, the technologies for logic verification are discussed in Japanese Laid-open Patent Publication No. 2001-101247 and Japanese Laid-open Patent Publication No. 2007-40892.

However, in the above-described related arts, when multiple hardware units operating in synchronization with each other are included in a verification target circuit, it may be difficult to reduce an amount of circuits of a verification model. For example, when multiple hardware units operate in synchronization with each other, the multiple hardware units have equivalent configuration with each other. Thus, it is probable that an amount of circuits of a verification model may not be reduced desirably because it is difficult to simplify the circuit configuration in the multiple hardware units operating in synchronization with each other.

In addition, when the concept of “clock” is absent in a behavioral model, an interface converter is generally used for coupling the behavioral model to a model described at a register transfer level. Thus, additional design and verification for an interface converter that is not mounted on a real machine is desired. Moreover, in a behavioral model described at a behavior level, it may be difficult to verify actual circuit operations accurately in the register transfer level.

### SUMMARY

A computer-readable recording medium configured to store a verification support program, the program causing a computer to execute logic verification operations for a system including a plurality of control circuits, and a plurality of hardware units that correspond to the control circuits. The logic verification operations are executed using a verification model of the system. The verification model includes a control circuit model which has a function of the control circuit, and a plurality of hardware models which have functions of the plurality of hardware units. The logic verification operations include accepting instructions from the plurality of hardware models by the control circuit model; selecting an instruction to be processed by one of the plurality of hardware models from the accepted instructions by the control circuit model; and reporting a processing request of the selected instruction to the plurality of hardware models by the control circuit model.

Advantages of the various embodiments will be realized and attained by means of the elements and combinations particularly pointed out in the claims.

It is to be understood that both the foregoing general description and the following detailed description are exemplary and explanatory and are not restrictive of the various embodiments, as claimed.

### BRIEF DESCRIPTION OF DRAWINGS

FIG. 1 illustrates an exemplary verification target circuit according to a first embodiment;

FIG. 2 illustrates an exemplary verification model of the verification target circuit according to the first embodiment;

FIG. 3 illustrates an exemplary hardware model that is regarded as a verification target;

FIG. 4 illustrates an exemplary hardware model that is not regarded as a verification target;

FIG. 5 illustrates hardware configuration of a logic verification device according to the first embodiment;

FIG. 6 illustrates an exemplary operation of the verification model according to the first embodiment;

FIG. 7 illustrates an exemplary verification target circuit according to a second embodiment;

FIG. 8 illustrates exemplary queue configuration in a priority control unit;

FIG. 9A and FIG. 9B illustrate an exemplary selection operation for memory requests;

FIG. 10 illustrates an exemplary operation in an SMP system according to the second embodiment;

FIG. 11 illustrates exemplary storage contents in an operation instruction table;

FIG. 12 illustrates an exemplary verification model in the SMP system according to the second embodiment;

FIG. 13 illustrates an exemplary pseudo system board model;

FIG. 14 illustrates functional configuration of a priority control unit model;

FIG. 15 illustrates exemplary processing of a report unit of the priority control unit model;

FIG. 16 illustrates an exemplary flowchart of operation procedure in the priority control unit model;

FIG. 17 illustrates an exemplary pseudo CPU model;

FIG. 18 illustrates an exemplary pseudo main memory model;

FIG. 19 illustrates an exemplary pseudo I/O model;

FIG. 20 illustrates a modified example of the verification target circuit according to the second embodiment;

FIG. 21 illustrates another exemplary operation in the SMP system according to the second embodiment; and

FIG. 22 illustrates a verification model of the modified example of the verification target circuit according to the second embodiment.

### DESCRIPTION OF EMBODIMENTS

A verification support program, a logic verification device, and verification support method according to embodiments will be described in detail with reference to the attached drawings.

### A First Embodiment

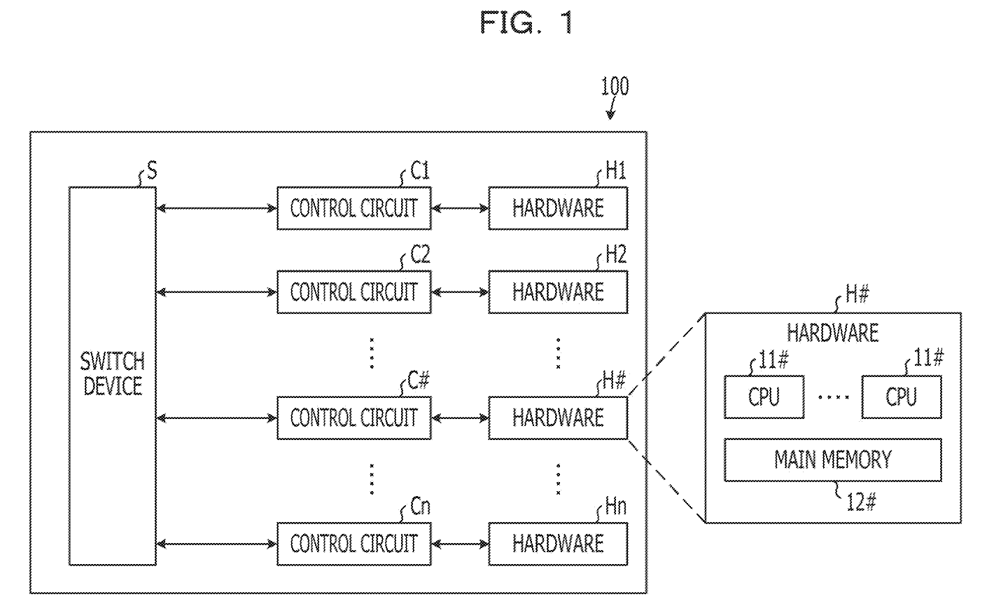

FIG. 1 illustrates an exemplary verification target circuit according to a first embodiment. In FIG. 1, a system 100 includes multiple hardware units H1 to Hn, multiple control circuits C1 to Cn, and a switch device S. In the system 100, the multiple control circuits C1 to Cn are coupled to each other through the switch device S. In addition, the control circuits C1 to Cn are directly coupled to the corresponding hardware units H1 to Hn, respectively.

The system 100 is a verification target circuit regarded as a target for logic verification. In the logic verification, whether or not circuits described based on their specification, operate as specified is verified in the stage of logic design. For example, the system 100 may be a super computer or a large server system such as a data center server with SMP configuration.

The hardware units H1 to Hn are hardware regarded as a target for logic verification and may be, for example, system boards or a Large Scale Integrations (LSI). The hardware H# may include, for example, multiple CPUs 11# and a main memory 12# (#=1, 2, . . . , n). The CPUs 11# may process various instructions. The main memory 12# is a storage device such as a Read Only Memory (ROM) and a Random Access Memory (RAM) that are accessible by the CPU 11#.

The control circuits C1 to Cn are hardware which operate in synchronization with each other and include circuit configurations which are substantially equivalent with each. For example, the control circuit C# may receive instructions issued from the multiple hardware units H1 to Hn through the switch device S. For example, the instruction may be a memory request to access one of the main memories 12# in the system 100. For example, instructions received by the control circuit C# are registered in the queues of the control circuit C#. The control circuit C# may include two or more queues with respect to the issuer of an instruction or the type of an instruction, etc. For example, the queues may be utilized by arranging a first in first out (FIFO) memory in series.

The control circuit C# selects an instruction to be processed by the hardware H# that is directly coupled to the control circuit C# from the instructions issued from the multiple hardware units H1 to Hn. For example, the control circuit C# selects an instruction that is a target to be processed from the instructions registered in the queues using a selection algorithm based on the circuit configuration of the control circuit C#.

The switch device S is a relay device to relay data between the control circuits C1 to Cn. For example, the switch device S corresponds to a crossbar switch dynamically selecting a path when data is transmitted and received between the control circuits C1 to Cn.

In the system 100, instructions issued from the multiple hardware units H1 to Hn are broadcasted to the control circuits C1 to Cn through the switch device S and registered in the queues of each of the control circuits C#. In addition, the selection algorithm used for selecting an instruction of the each of the control circuits C# is the same because the circuit configuration of the multiple control circuits C1 to Cn are equivalent.

Thus, in the system 100, when the control circuits C1 to Cn operate in synchrony with a clock, the instructions registered in the queues of each of the control circuits C# is processed in the same order. In FIG. 1, the hardware H# and the control circuit C# are separately provided to the system 100, alternatively, the control circuit C# may be mounted on the hardware H# in the system 100.

(An Exemplary Verification Model)

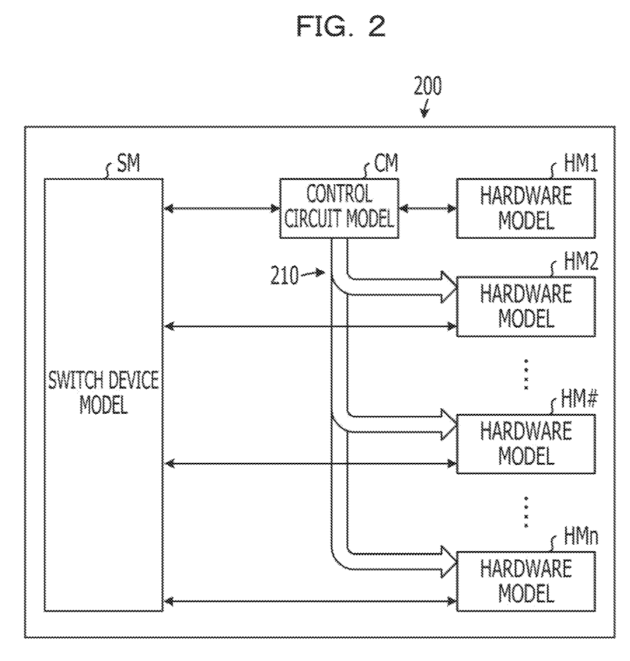

FIG. 2 illustrates an exemplary verification model of the verification target circuit according to the first embodiment. In FIG. 2, a verification model 200 includes multiple hardware models HM1 to HMn, a control circuit model CM, and a switch device model SM.

The verification model 200 performs logic verification for the system 100 illustrated in FIG. 1. The verification model 200 is described using a hardware description language such as a Verilog Hardware Description Language (Verilog HDL) or a VHSIC Hardware Description Language (VHDL).

The hardware model HM# is obtained by modeling a function of the hardware H# (see FIG. 1). The control circuit model CM is obtained by modeling a function of any one of the multiple control circuits C1 to Cn (see FIG. 1), that is, a control circuit C# (here, the control circuit C1). The switch device model SM is obtained by modeling a function of the switch device S.

In the verification model 200, the control circuit model CM is directly coupled to any one of the hardware models HM1 to HMn, that is, a HM# (here, the hardware model HM1). The hardware model HM1 is obtained by modeling a function of the hardware H1 directly coupled to the control circuit C1. In addition, the control circuit model CM is coupled to the hardware models HM2 to HMn through the switch device model SM. Each of the hardware models HM2 to HMn is obtained by modeling a function of each of the hardware H2 to Hn directly coupled to each of the control circuits C2 to Cn other than the control circuit C1, respectively.

In addition, the control circuit model CM is directly coupled to the hardware models HM2 to HMn through a signal line 210. The signal line 210 may not perform connection on an actual circuit, that is, on the system 100 of FIG. 1 due to physical limitations, and may generally exist on the verification model 200. For example, similar to actual design description, the signal line 210 may be described using the hardware description language for the description of a verification target circuit.

An exemplary hardware model HM# is described below. In logic verification for the large-scale system 100 such as a large server system, a mere part of the system 100 is regarded as a verification target, and the verification model 200 corresponding to the verification target is create because an amount of a circuit of a verification model that may be built on the simulator is limited.

Thus, in hardware other than the hardware H1 to Hn regarded as verification targets, a function required for logic verification generally may be modeled, thereby reducing amount of circuits required for the configuration of the verification model. Examples of a hardware model that is regarded as a verification target and a hardware model that is not regarded as verification target are described below with reference to a case where the hardware H1 is regarded as a verification target from among the hardware H1 to Hn.

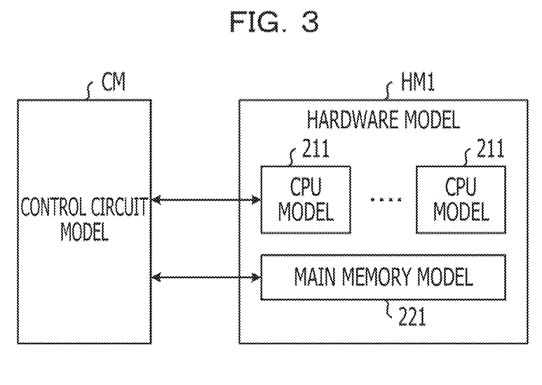

FIG. 3 illustrates an exemplary hardware model regarded as a verification target. In FIG. 3, the hardware model HM1 includes multiple CPU models 211 and a main memory model 221. The CPU models 211 and the main memory model 221 are directly coupled to the control circuit model CM.

The CPU model 211 is obtained by modeling a function of a CPU 111 in the hardware H1 (see FIG. 1: #=1). The main memory model 221 is obtained by modeling a function of a main memory 121 in the hardware H1 (see FIG. 1: #=1).

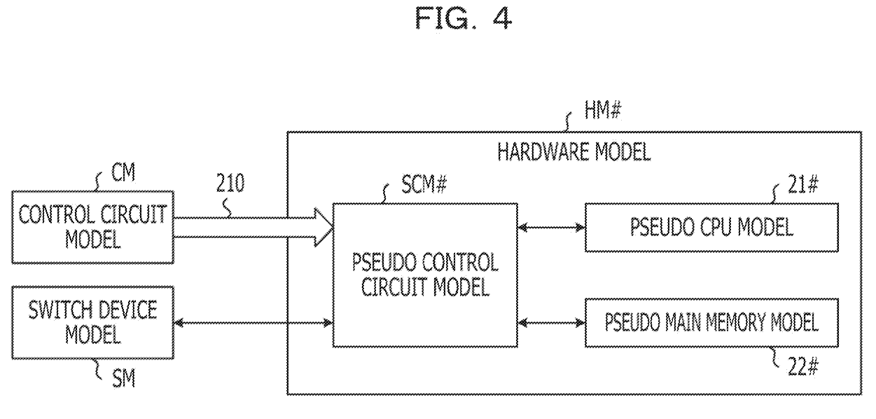

FIG. 4 illustrates an exemplary hardware model that is not regarded as a verification target. In FIG. 4, the hardware model HM# includes a pseudo control circuit model SCM#, a pseudo CPU model 21#, and a pseudo main memory model 22# (here, #=2, 3, . . . , n). The pseudo control circuit model SCM# is directly coupled to the control circuit model CM and the switch device model SM.

The pseudo control circuit model SCM# generally is obtained by modeling a mere function required for logic verification from among functions of the control circuit C# (see FIG. 1: #=2, 3, . . . , n). The pseudo CPU model 21# generally is obtained by modeling a mere function required for logic verification from among functions of the CPU 11# (see FIG. 1: #=2, 3, . . . , n). The pseudo main memory model 22# generally is obtained by modeling a mere function required for logic verification from among functions of the main memory 12# (see FIG. 1: #=2, 3, . . . , n).

(Hardware Configuration of a Logic Verification Device)

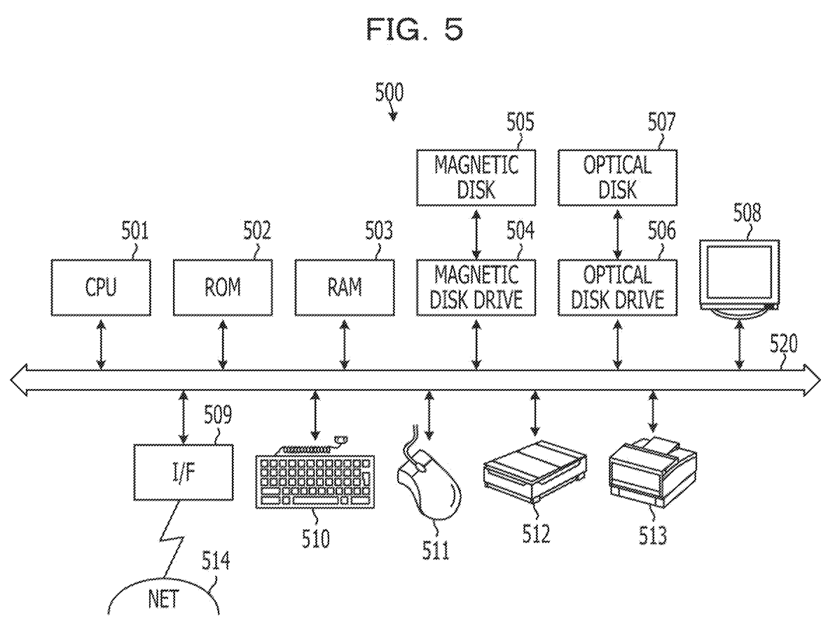

FIG. 5 illustrates hardware configuration of a logic verification device according to the first embodiment. In FIG. 5, a logic verification device 500 includes a CPU 501, a ROM 502, a RAM 503, a magnetic disk drive 504, a magnetic disk 505, an optical disk drive 506, an optical disk 507, a display 508, an interface (I/F) 509, a keyboard 510, a mouse 511, a scanner 512, and a printer 513. In addition, the configuration units are coupled to each other through a bus 520 as illustrated in FIG. 5.

The CPU 501 controls the whole logic verification device 500. The ROM 502 stores programs such as a boot program and a logic verification test program. The RAM 503 is used as a work area for the CPU 501. The magnetic disk drive 504 controls data read/write from and to the magnetic disk 505 based on the control of the CPU 501. The magnetic disk 505 stores data written based on the control by the magnetic disk drive 504.

The optical disk drive 506 controls data read/write from and to the optical disk 507 based on the control of the CPU 501. The optical disk 507 stores data written based on the control by the optical disk drive 506 and causes a computer to read data stored in the optical disk 507.

The display 508 displays a cursor, an icon, a tool box, and data such as a document, an image, and functional information. The display 508 may employ, for example, a cathode-ray tube (CRT), a thin-film transistor (TFT) liquid crystal display, a plasma display, etc.

The I/F 509 is coupled to a network 514 such as a local area network (LAN), a wide area network (WAN), or the Internet, through a communication line and coupled to another device through the network 514. In addition, the I/F 509 takes charge of the network 514 and internal interfaces and controls data input/output from external devices. For example, the I/F 509 may employ a modem, a LAN adapter, etc.

The keyboard 510 includes keys for inputs such as characters, numbers, various instructions and inputs data using the keys. Alternatively, a touch-screen input pad, a numeric keypad, etc., may be employed instead of the keyboard 510. The mouse 511 performs cursor control, range selection, window control, or window size change. A trackball, a joystick, etc., may be also employed as a function of a pointing device, instead of the mouse 511.

The scanner 512 optically reads an image and captures the image data in the logic verification device 500. The scanner 512 may include an optical character reader (OCR) function. In addition, the printer 513 prints image data and document data. For example, the printer 513 may employ a laser printer, an inkjet printer, etc. Some of the configuration units (for example, the scanner 512, the printer 513, etc.) among the above-described configuration units 501 to 513 may be omitted from the logic verification device 500.

(An Exemplary Operation of the Verification Model 200)

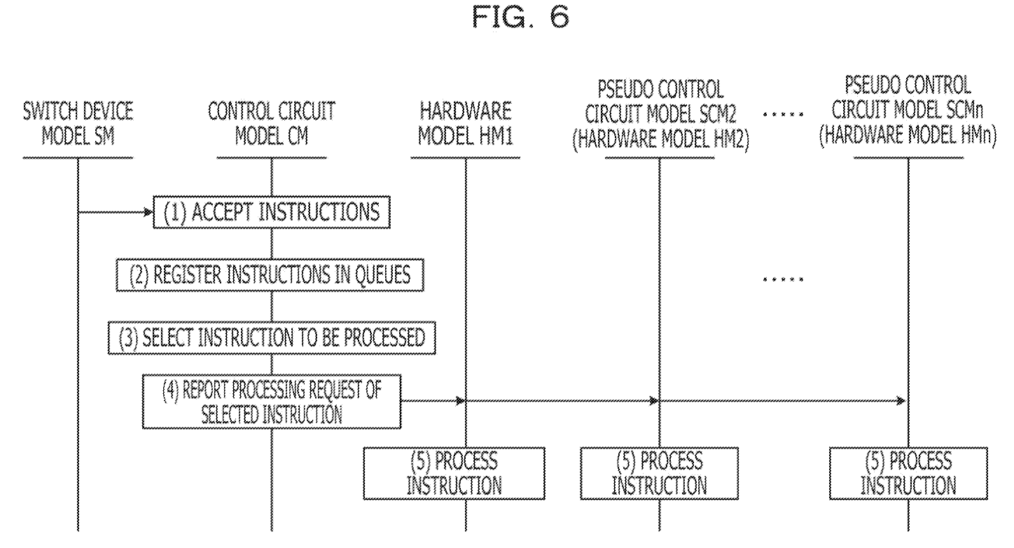

FIG. 6 illustrates an exemplary operation of the verification model 200 according to the first embodiment. In the exemplary operation of the verification model 200 described below, logic verification may be performed by inputting descriptive data or test pattern of the verification model 200 to the logic verification device 500 illustrated in FIG. 5.

In FIG. 6, (1) the control circuit model CM accepts instructions from the multiple hardware models HM1 to HMn through the switch device model SM.

(2) The control circuit model CM registers the accepted instructions in the queues of the control circuit model CM.

(3) The control circuit model CM selects an instruction to be processed by the hardware model HM1 from the instructions registered in the queues. The hardware model HM1 is obtained by modeling a function of the hardware H1 directly coupled to the control circuit C1 which is model source of the control circuit model CM. For example, the control circuit model CM selects an instruction to be processed using a selection algorithm based on the circuit configuration in the control circuit C#.

(4) The control circuit model CM reports a processing request of the selected instruction to the hardware models HM1 to HMn. For example, the control circuit model CM reports the processing request for the instruction to the CPU models 211 in the hardware model HM1 while reporting the processing request for the instruction to pseudo control circuit models SCM2 to SCMn in the hardware models HM2 to HMn. The execution request for the instruction reported to each of the pseudo control circuit models SCM2 to SCMn is reported to each of the hardware models HM2 to HMn, respectively.

(5) Each of the hardware models HM1 to HMn processes the instruction requested from the control circuit model CM. For example, the CPU models 211 in the hardware model HM1 processes the instruction while each of the pseudo CPU models 212 to 21n corresponding to each of the hardware models HM2 to HMn processes the instruction. In the operation of “(4)”, the control circuit model CM may directly report a processing request for an instruction to each of the pseudo CPU models 212 to 21n corresponding to each of the hardware models HM2 to HMn without through each of the pseudo control circuit models SCM2 to SCMn.

As described above, in the verification model 200 according to the first embodiment, a processing request for an instruction may be reported to the hardware models HM1 to HMn by the control circuit model CM through the signal line 210, which does not exist in the system 100, on the verification model 200. Thus, an instruction to be processed is selected, and functions where each of the control circuits C1 to Cn report the instruction to be processed to each of the hardware models HM1 to HMn may be integrated, thereby causing an amount of circuits of the verification model 200 to be reduced.

In addition, in the verification model 200, when the verification model 200 is described at a register transfer level or a gate level, the control circuit model CM may operate in synchronization with a clock. As a result, a processing request for an instruction may be reported from the control circuit model CM in synchronization with the clock, and the hardware models HM1 to HMn may operate in synchronization with the clock accuracy. Moreover, the hardware models may operate in synchronization with the clock accuracy without an interface converter, etc., the verification model 200.

In addition, in the verification model 200, a processing request for an instruction may be reported from the control circuit model CM to each of the hardware models HM2 to HMn through the signal lines 210 that directly couples the control circuit model CM to the hardware models HM2 to HMn. Thus, in the hardware model HM#, a relay circuit between the pseudo control circuit model SCM#, the pseudo CPU model 21#, and the pseudo main memory model 22# may be omitted, thereby allowing the simplified hardware model HM# to be designed.

### A Second Embodiment

A verification target circuit according to a second embodiment is described below. The illustration and description of configurations similar to the configuration in the first embodiment are omitted here. In addition, hereinafter, the control circuits C1 to Cn are referred to as “priority control unit P1 to Pn”, the control circuit model CM is referred to as “priority control unit model PM”, and the pseudo control circuit model SCM is referred to as “pseudo priority control unit model SPM”.

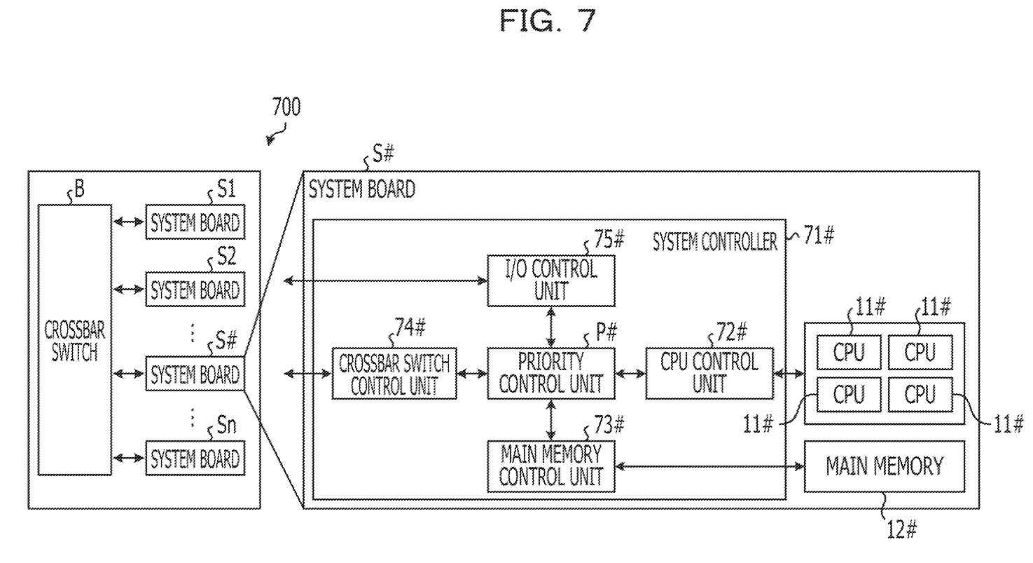

FIG. 7 illustrates an exemplary verification target circuit according to the second embodiment. In FIG. 7, an SMP system 700 includes multiple system boards S1 to Sn and a crossbar switch B. In the SMP system 700, the multiple system boards S1 to Sn are coupled to each other through the crossbar switch B.

The SMP system 700 may be a verification target circuit including the system boards S1 to Sn regarded as targets for logic verification. The SMP system 700 may be an SMP system where multiple CPU 11# (#=1, 2, . . . , n) in the system boards S1 to Sn divide processing equally.

The system board S# includes a system controller 71#, multiple CPU 11#, and a main memory 12#. The system controller 71# includes a priority control unit P#, a CPU control unit 72#, a main memory control unit 73#, a crossbar switch control unit 74#, and an I/O control unit 75#. The system board S# corresponds to the hardware H# illustrated in FIG. 1.

The priority control units P1 to Pn are circuits which operate in synchronization with each other and configurations of which are equivalent. The priority control unit P# accepts memory requests issued from the multiple system boards S1 to Sn through the crossbar switch B. The memory request is utilized to share data between memories (that is, main memories 121 to 12n) by multiple CPU 111 to 11n in the SMP system 700. That is, the memory request is utilized to maintain data coherency in the SMP system 700.

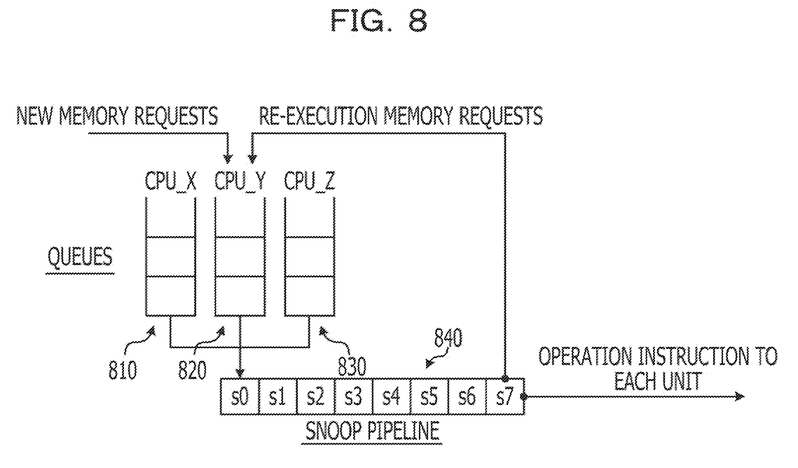

For example, a memory request is information including the physical address of a memory (that is, request destination), the number of CPU (that is, request source), the request type of data such as shared type or exclusive type, a packet number, etc. The memory requests accepted by the priority control unit P# may be stored, for example, in the queues of the priority control unit P#. Exemplary queues of the priority control unit P# are described later with reference to FIG. 8.

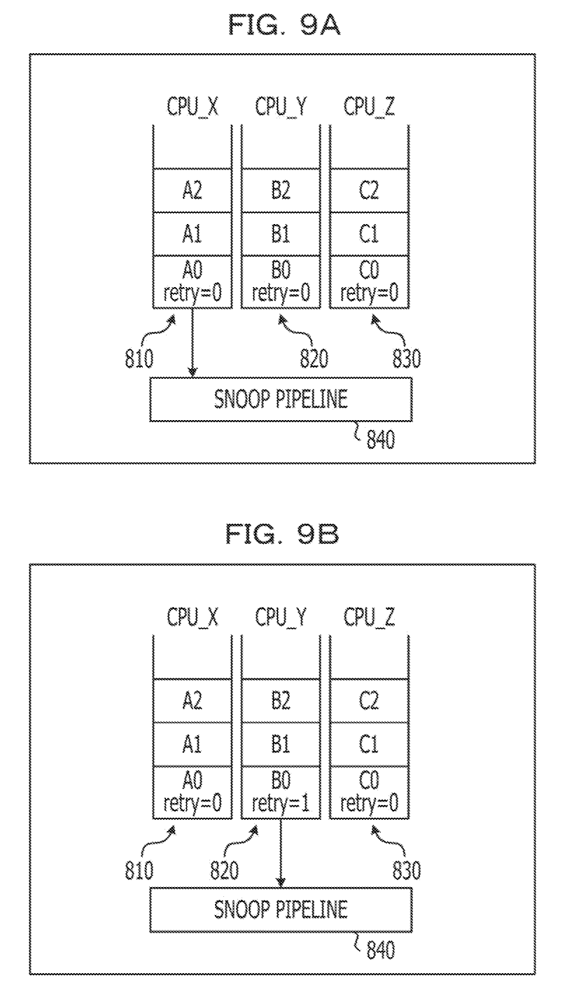

The priority control unit P# selects a memory request to be processed by the system board S# from the memory requests stored in the queues based on a certain selection algorithm. An exemplary selection operation for memory requests is described later with reference to FIG. 9A and FIG. 9B.

The CPU control unit 72# controls the multiple CPU 11#. The main memory control unit 73# controls the main memory 12#. The crossbar switch control unit 74# controls the crossbar switch B. The I/O control unit 75# controls data input/output with respect to the priority control unit P#.

The crossbar switch B dynamically selects a path when the crossbar switch B transmits and receives data between the priority control units P1 to Pn. For example, the crossbar switch B selects a path for transmitting and receiving data, based on the control of the crossbar switch control unit 74#. The crossbar switch B corresponds to the switch device S illustrated in FIG. 1.

(An Exemplary Queue Configuration of the Priority Control Unit P#)

In FIG. 8, an exemplary queue configuration of the priority control unit is described with reference to “CPU_X”, “CPU_Y”, and “CPU_Z” from which a memory request is issued. Each of the “CPU_X”, “CPU_Y”, and “CPU_Z” corresponds to any one of CPU in the SMP system 700.

In FIG. 8, the priority control unit P# includes queues 810, 820, and 830 in the corresponding “CPU_X”, “CPU_Y”, and “CPU_Z” from which a memory request is issued. In the queues 810, 820, and 830, re-execution memory requests in addition to new memory requests from the corresponding “CPU_X”, “CPU_Y”, and “CPU_Z” are registered.

The priority control unit P# selects a memory request to be processed based on the certain selection algorithm so that the memory requests registered in the queues 810, 820, and 830 are desirably processed and equally processed as appropriate. In addition, the priority control unit P# issues the selected memory request to a snoop pipeline 840.

The snoop pipeline 840 may be used for pipeline processing by the priority control unit P# and include stages s0 to s7. The processing performed in each of the stages s0 to s7 is decided previously, and the processing is performed in order of s0 to s1 to s2 to s3 to s4 to s5 to s6 to s7. For example, the snoop pipeline 840 may be performed using a memory circuit such as multiple flip-flops.

FIG. 9A and FIG. 9B illustrates an exemplary selection operation for a memory request. In FIG. 9A, memory requests A0, A1, and A2 are registered in the queue 810 corresponding to the “CPU_X”. Memory requests B0, B1, and B2 are registered in the queue 820 corresponding to the “CPU_Y”. Memory requests C0, C1, and C2 are registered in the queue 830 corresponding to the “CPU_Z”.

The priority control unit P# selects a memory request having the largest number of retries as a processing target from leading memory requests of the queues 810, 820, and 830. The number of retries is counted each time a memory request issued to the snoop pipeline 840 is transmitted back to the queues 810, 820, and 830 as a re-execute memory request based on the main memory 12# usage, etc.

In addition, when there are the leading memory requests that have the same number of retries, the priority control unit P# selects a memory request to be processed based on the priority order among the queues 810, 820, and 830. In this case, the priority order of the queue 810 may be highest, and the priority order of the queue 830 may be lowest.

As illustrated in FIG. 9A, the number of retries is “0” in each leading memory request A0, B0, and C0 corresponding to each of the queues 810, 820, and 830. In this case, the priority control unit P# selects the leading memory request A0 of the queue 810 having the highest priority order as a processing target and issues the leading memory request A0 to the snoop pipeline 840.

As illustrated in FIG. 9B, the number of retries is “0” in the each of the leading memory requests A0 and C0 corresponding to each of the queues 810 and 830, and the number of retries is “1” in the leading memory request B0 corresponding to the queue 820. In this case, the priority control unit P# selects the memory request B0 having the largest number of retries as a processing target and issues the leading memory request B0 to the snoop pipeline 840.

(An Exemplary Operation in the SMP System 700)

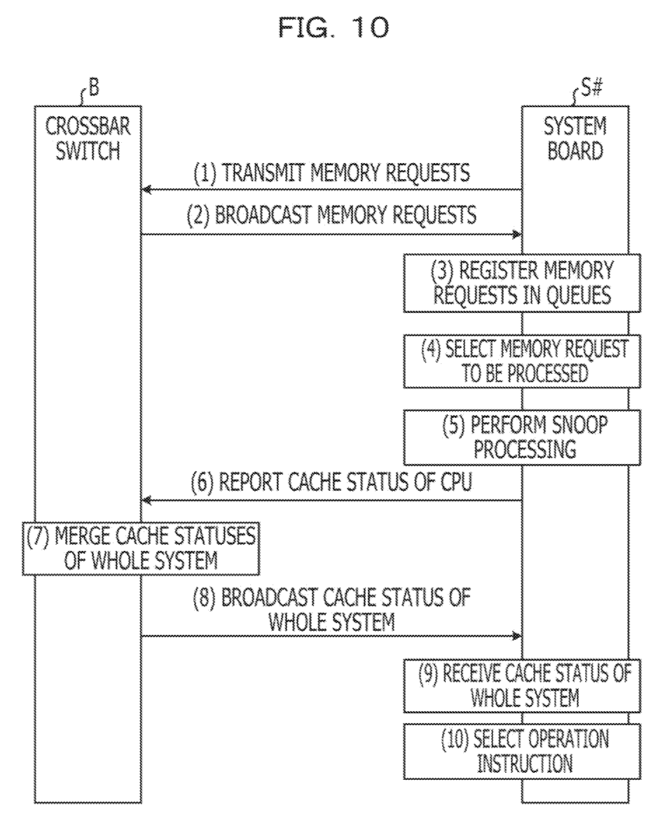

FIG. 10 illustrates an exemplary operation in the SMP system 700 according to the second embodiment. An operation sequence between the system board S# and the crossbar switch B in the SMP system 700 is described below. In FIG. 10, (1) the priority control unit P# in the system board S# transmits a memory request issued from the CPU 11# to the crossbar switch B through the I/O control unit 75#.

(2) The crossbar switch B receives the memory request from the system board S# and broadcast the memory request to the system boards S1 to Sn. That is, the crossbar switch B inputs the same clock and the same memory request to each of the priority control units P1 to Pn. As a result, the priority control units P1 to Pn operate in synchronization with each other.

(3) The priority control unit P# in the system board S# accepts the memory requests from the crossbar switch B and registers the memory requests in the queues.

(4) The priority control unit P# in the system board S# selects a memory request to be processed by the CPU 11# included in the system board S# from the memory requests registered in the queues. The processing in the “(4)” corresponds to processing in the stage s0 of the snoop pipeline 840 of the priority control unit P#.

(5) The priority control unit P# in the system board S# performs snoop processing with respect to the selected memory request. For example, the priority control unit P# transmits a snoop request that inquires whether or not data of a memory (that is, a request destination) is cached, to the CPU 11#. In addition, the priority control unit P# receives a snoop response indicating a cache status of the CPU 11#, from the CPU 11#. The processing in the “(5)” corresponds to processing in the stage s1 of the snoop pipeline 840. For example, cache statuses of the CPU 11# include four states based on a MESI protocol. The four states are as follows.

M (Modified): The cache line is present merely in the cache of the CPU 11#, and the value in the cache is modified from the value in the main memory 12#.

E (Exclusive): The cache line is present merely in the cache of the CPU 11#, however, the value in the cache matches the value in the main memory 12#.

S (Shared): The same cache line may also be stored in a cache of other CPU in the SMP system 700/

I (Invalid): The cache line is invalid.

(6) The priority control unit P# in the system board S# reports the cache status of the CPU 11# in the system board S# to the crossbar switch B. The processing in the “(6)” corresponds to processing in the stage s2 of the snoop pipeline 840.

(7) The crossbar switch B merges cache statuses reported from each of the system boards S1 to Sn. That is, cache statuses from each of the system boards S1 to Sn are integrated together as a cache status of the whole system in the SMP system 700.

(8) The crossbar switch B broadcasts the cache status of the whole system to the system boards S1 to Sn.

(9) The priority control unit P# in the system board S# receives the cache status of the whole system from the crossbar switch B. In the (9), processing that waits for the reception of the cache status of the whole system corresponds to processing in the stages s3 to s5 of the snoop pipeline 840. In addition, in the (9), processing that receives the cache status of the whole system corresponds to processing in the stages s6 of the snoop pipeline 840.

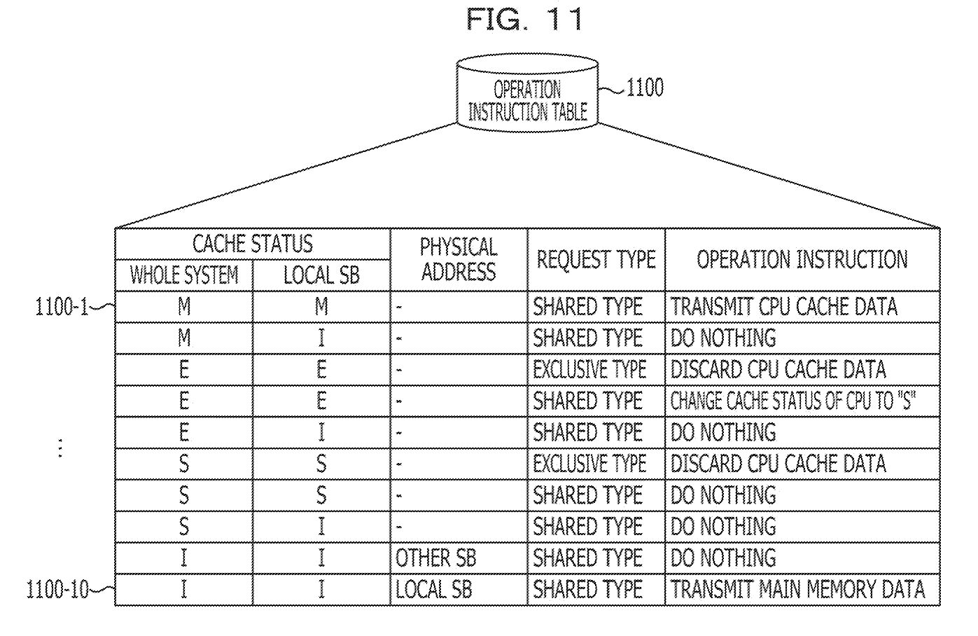

(10) The priority control unit P# in the system board S# selects an operation instruction to the units in the system board S# based on the cache status of the whole system and the cache statuses of the CPU 11#. For example, the priority control unit P# selects an operation instruction to the CPU 11# with reference to the operation instruction table 1100 illustrated in FIG. 11. The processing in the “(10)” corresponds to processing in the stage s7 of the snoop pipeline 840.

FIG. 11 illustrates exemplary memory contents of the operation instruction table. In the FIG. 11, the operation instruction table 1100 includes the fields of a cache status including a cache status of a whole system and a cache status of a local system board (local SB), a physical address, request type, and an operation instruction. Information is set in each of the fields, so that operation instruction information 1100-1 to 1100-10 is stored as records.

For example, the operation instruction table 1100 is held by each of the priority control unit P# in the corresponding system board S#. In this case, a cache status of the whole system corresponds to a cache status of the whole system in the SMP system 700. In addition, a cache status of the local SB corresponds to a cache status of the CPU 11#. That is, a cache status of the CPU 11# included in the system board S# where the priority control unit P# is also included corresponds to a cache status of the local SB.

In FIG. 11, the “physical address” corresponds to a physical address of a memory such as the main memories 121 to 12n (that is, request destination) and the physical address is included in a memory request. The “request type” corresponds to the request type of data. The “operation instruction” corresponds to an operation instruction for giving an instruction to each unit. For example, the “units” correspond to the CPU 11#, the main memory 12#, the I/O control unit 75#, etc., that are included in the system board S#.

For example, in the operation instruction information 1100-1, when cache statuses of the whole system and the local SB are “M” and request type is “shared type”, the priority control unit P# performs an operation instruction for transmitting the cache data to other system boards S# (“TRANSMIT CPU CACHE DATA” illustrated in FIG. 11), to the CPU 11#.

(An Exemplary Verification Model)

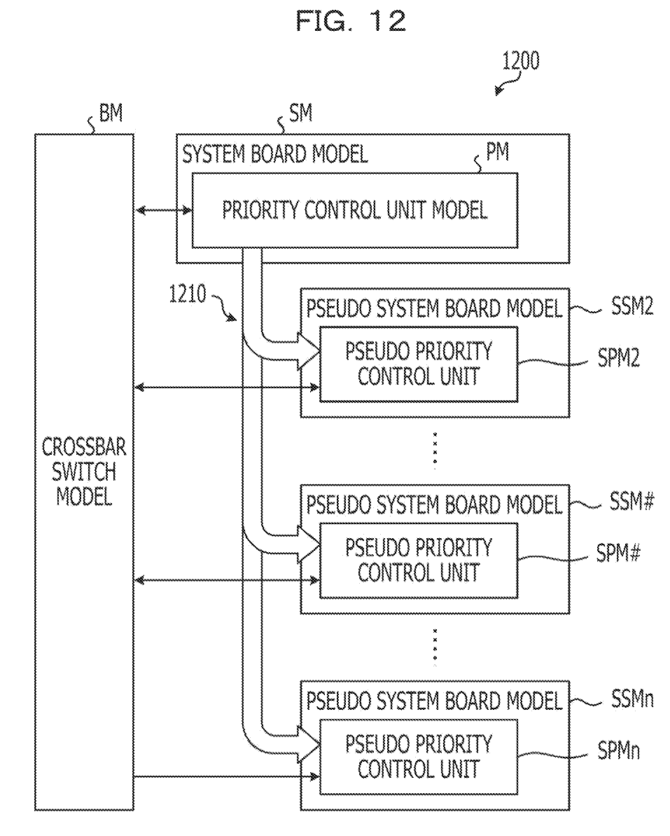

FIG. 12 illustrates an exemplary verification model in the SMP system according to the second embodiment. In FIG. 12, a verification model 1200 includes a system board model SM, a priority control unit model PM, pseudo system board models SSM2 to SSMn, and pseudo priority control unit models SPM2 to SPMn.

The system board model SM is obtained by modeling a function of the system board S1 (see FIG. 7). The priority control unit model PM is obtained by modeling a function of the priority control unit P1 in the system board S1. The system board model SM includes the models obtained by modeling functions of the system controller 711, the CPU 111, and the main memory 121 in the system board S1 (not illustrated).

The pseudo system board model SSM# is obtained by modeling a simplified function of the system board S# (see FIG. 7, and #=2, 3, . . . , n). The pseudo priority control unit model SPM# is obtained by modeling a simplified function of the priority control unit P# in the system board S# (#=2, 3, . . . , n). The crossbar switch model BM is obtained by modeling a function of the crossbar switch B (see FIG. 7).

In the verification model 1200, the priority control unit model PM is coupled to pseudo priority control unit models SPM2 to SPMn through the crossbar switch model BM. In addition, the priority control unit model PM is directly coupled to the pseudo priority control unit models SPM2 to SPMn through a signal line 1210. The signal line 1210 may not perform connection on the actual circuit (that is, on the SMP system 700) due to physical limitation and may be a signal line existing merely on the verification model 1200.

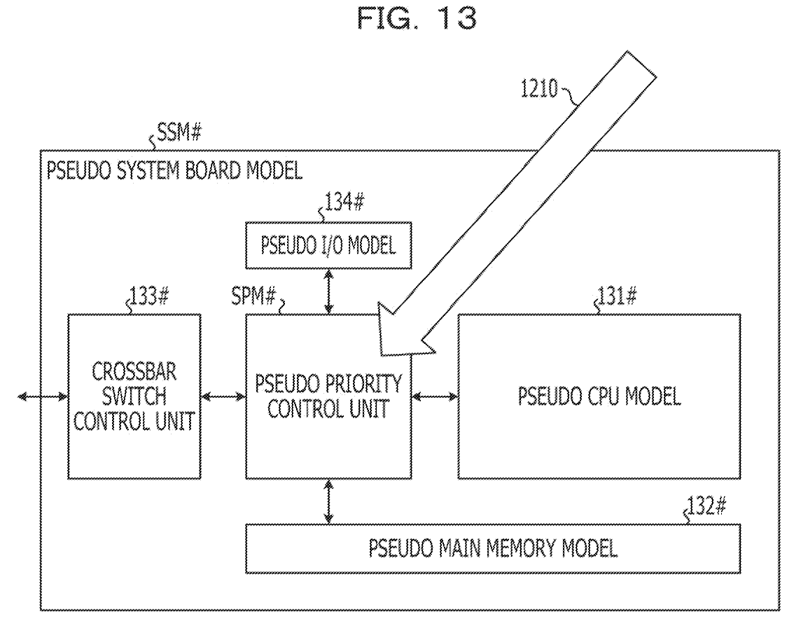

FIG. 13 illustrates an exemplary pseudo system board model. In FIG. 13, the pseudo system board model SSM# includes a pseudo priority control unit model SPM#, a pseudo CPU model 131#, a pseudo main memory model 132#, a crossbar switch control unit model 133#, and a pseudo I/O model 134# (here, #=2, 3, . . . , n).

The pseudo priority control unit model SPM# generally is obtained by modeling a mere function required for logic verification from among functions of the priority control unit P#. The pseudo CPU model 131# generally is obtained by modeling a mere function required for logic verification from among functions of the CPU 11#. The pseudo main memory model 132# generally is obtained by modeling a mere function required for logic verification from among functions of the main memory 12#.

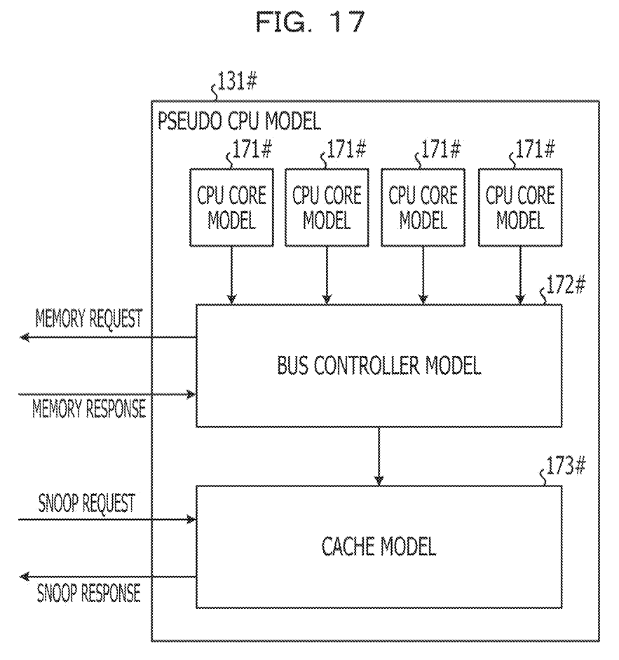

The crossbar switch control unit model 133# is obtained by modeling a function of the crossbar switch control unit 74#. The pseudo I/O model 134# generally is obtained by modeling a mere function required for logic verification from among functions of the I/O control unit 75#. Examples of the pseudo CPU model 131#, the pseudo main memory model 132#, and the pseudo I/O model 134# are described later with respect to FIGS. 17 to 19.

In the pseudo system board model SSM#, the pseudo priority control unit model SPM# is directly coupled to the pseudo CPU model 131#, the pseudo main memory model 132#, and the pseudo I/O model 134#. Thus, the pseudo system board model SSM# may be simplified and then designed in comparison with a case where the system board S# illustrated in FIG. 7 is modeled as is. As a result, the logic scale of the verification model 1200 may be reduced, and the labor saving in the design and verification of the verification model 1200 may be increased.

(Functional Configuration of the Priority Control Unit Model PM)

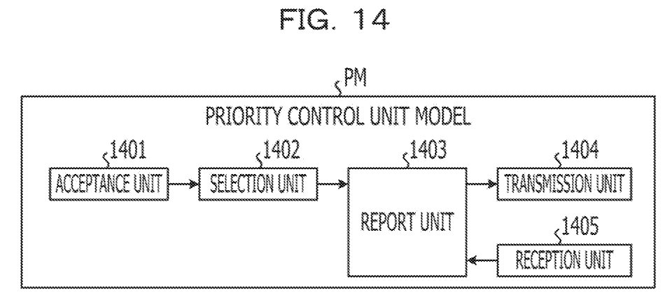

FIG. 14 illustrates functional configuration of the priority control unit model. In FIG. 14, the priority control unit model PM includes an acceptance unit 1401, a selection unit 1402, a report unit 1403, a transmission unit 1404, and a reception unit 1405.

The acceptance unit 1401 accepts memory requests issued from the system board model SM and the pseudo system board models SSM2 to SSMn through the crossbar switch model BM. The accepted memory requests are registered in the queues of the priority control unit model PM. For example, each queue in the priority control unit model PM is obtained by modeling each of the queues 810, 820, and 830 illustrated in FIG. 8.

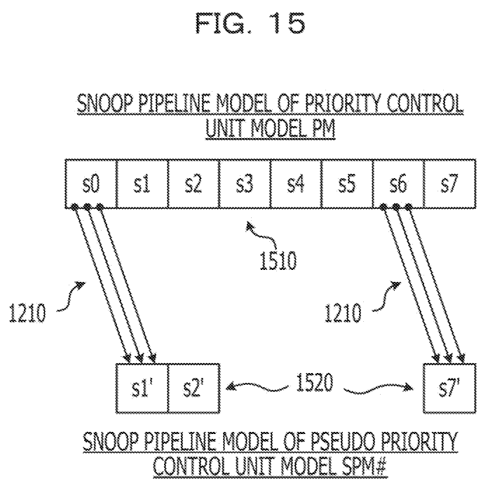

The selection unit 1402 select a memory request to be processed by the system board model SM from the memory requests registered in the queues. For example, the selection unit 1402 selects a memory request to be processed based on the same selection algorithm as a selection algorithm of the priority control unit P#. The selected memory request is issued to a snoop pipeline model 1510 (see FIG. 15).

A report unit 1403 reports the selected memory request to the system board model SM and the pseudo system board models SSM2 to SSMn. For example, the report unit 1403 issues the selected memory to the snoop pipeline model 1510 of the priority control unit model PM and the snoop pipeline model 1520 of the pseudo priority control unit models SPM2 to SPMn (see FIG. 15). The processing of the report unit 1403 is described later with reference to FIG. 15.

The transmission unit 1404 transmits a cache status of a CPU model in the system board model SM obtained after the report the selected memory request to system board model SM, to the crossbar switch model BM. The CPU model is obtained by modeling a function of the CPU 111 in the system board S1.

The reception unit 1405 receives a cache status of the whole system in the verification model 1200 from the crossbar switch model BM after the cache status of the CPU model is transmitted. In addition, the report unit 1403 reports the received cache status of the whole system to the system board model SM and the pseudo system board models SSM2 to SSMn.

For example, the report unit 1403 issues the cache status of the whole system to the snoop pipeline model 1510 of the priority control unit model PM and the snoop pipeline model 1520 of the pseudo priority control unit models SPM2 to SPMn (see FIG. 15). As a result, in the priority control unit model PM and the pseudo priority control unit models SPM2 to SPMn, an operation instruction is selected, and the operation instruction is transmitted to each of the units.

(The Processing of the Report Unit 1403)

FIG. 15 illustrates exemplary processing of the report unit 1403 of the priority control unit model PM. The snoop pipeline model 1510 included in the priority control unit model PM and the snoop pipeline model 1520 included in the pseudo priority control unit model SPM# are illustrated in FIG. 15.

The snoop pipeline model 1510 is obtained by modeling a function of the snoop pipeline 840 included in the priority control unit P#. For example, the snoop pipeline model 1510 includes stages s0 to s7. Each of the stages s0 to s7 of the snoop pipeline model 1510 corresponds to each of the stages s0 to s7 of the snoop pipeline 840, respectively.

The snoop pipeline model 1520 is obtained by modeling a simplified function of the snoop pipeline 840 included in the priority control unit P#. For example, the snoop pipeline model 1520 includes stages s1, s2′, and s7′. Each of the stages s1, s2′, and s7′ of the snoop pipeline model 1520 corresponds to each of the stages s1, s2, s7 of the snoop pipeline 840, respectively.

The stage s0 of the snoop pipeline model 1510 is coupled to the stage s1′ of the snoop pipeline model 1520 through the signal line 1210 for logic verification. In addition, the stage s6 of the snoop pipeline model 1510 is coupled to the stage s7′ of the snoop pipeline model 1520 through the signal line 1210 for logic verification. For example, in description data of the verification model 1200, when connection relationship and input/output relationship between the stages of the snoop pipeline model 1510 and the snoop pipeline model 1520 is defined in hardware description language, thereby performing the connection by the signal line 1210.

When a memory request is issued to the stage s0 of the snoop pipeline model 1510, the report unit 1403 issues the memory request to the stage s1 of the snoop pipeline model 1510 and the stage s1′ of the snoop pipeline model 1520 through the signal line 1210. A memory request issued to the stage s0 may be a memory request to be processed that is selected by the selection unit 1402.

In addition, when a cache status of the whole system is received in the stage s6 of the snoop pipeline model 1510, the report unit 1403 issues the cache status of the whole system to the stage s7 of the snoop pipeline model 1510 and the stage s7′ of the snoop pipeline model 1520.

In the snoop pipeline model 1510, processing results in each of the stages s0 to s6 are also issued to stages after the stage s6. Similar to the snoop pipeline model 1510, in the snoop pipeline model 1520, processing results in each of the stages s1′ and s2′ are also issued to stages after the stage s2′. For example, a memory request issued to the stage s0 of the snoop pipeline model 1510 is also issued to the stage s1. That is, information required for the subsequent processing is issued to stages after a stage where a memory request is issued.

As described above, when the stages of the snoop pipeline model 1510 and the snoop pipeline model 1520 are coupled each other, a memory request and a cache status of the whole system may be reported from the snoop pipeline model 1510 to the snoop pipeline model 1520. Thus, the pseudo priority control unit model SPM# may perform snoop operations before waiting for the queues. In addition, in the snoop pipeline model 1520 of the pseudo priority control unit model SPM#, the stages corresponding to the stage s0 and stages s3 to s6 of the snoop pipeline model 1510 may be omitted.

When the pseudo system board model SSM# corresponds to a circuit described at a register transfer level, signals may be referred to across the level of logic hierarchy in a general logic simulator. As a result, a connection for logic verification using the signal line 1210 may be performed without modification of an actual circuit.

(An Operation Procedure in the Priority Control Unit Model PM)

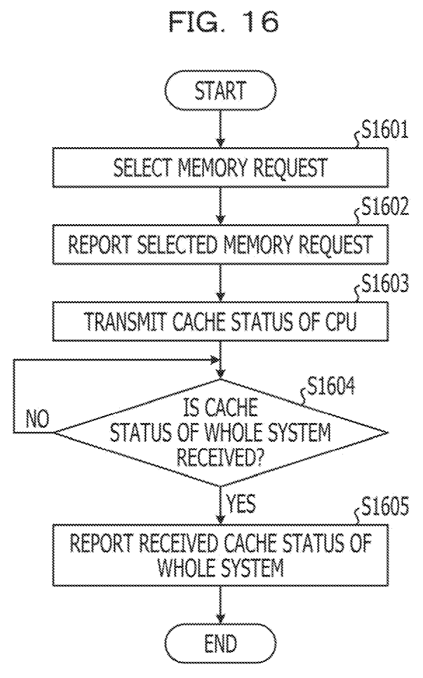

FIG. 16 illustrates a flowchart of an exemplary operation procedure in the priority control unit model PM. In FIG. 16, the selection unit 1402 selects a memory request to be processed by the system board model SM from the memory requests registered in the queues of the priority control unit model PM (Operation S1601).

In addition, the report unit 1403 reports the selected memory request to the system board model SM and the pseudo system board models SSM2 to SSMn (Operation S1602). After that, the transmission unit 1404 transmits a cache status of the CPU model in the system board model SM obtained after the memory request is reported to the system board model SM, to the crossbar switch model BM (Operation S1603).

After that, the reception unit 1405 determines whether or not a cache status of the whole system in the verification model 1200 is received from the crossbar switch model BM (Operation S1604). The reception unit 1405 waits for the reception of the cache status of the whole system (NO in Operation S1604).

In addition, when the cache status of the whole system in the verification model 1200 is received (YES in Operation S1604), the report unit 1403 reports the received cache status of the whole system to the system board model SM and the pseudo system board models SSM2 to SSMn (Operation S1605), and the operations in the priority control unit model PM end.

(An Exemplary Pseudo CPU Model 131#)

FIG. 17 illustrates an exemplary pseudo CPU model 131#. In FIG. 17, the pseudo CPU model 131# includes multiple CPU core models 171#, a bus controller model 172#, and a cache model 173#. The pseudo CPU model 131# may be designed to integrate the functions of the CPU control unit 72# in the system controller 71# illustrated in FIG. 7.

The CPU core model 171# generates a memory request and reports the memory request to the bus controller model 172#. The bus controller model 172# outputs the memory request to the pseudo priority control unit model SPM#. In addition, the bus controller model 172# receives a snoop request through the pseudo priority control unit model SPM#. Moreover, the bus controller model 172# performs a snoop operation and outputs a snoop response to the pseudo priority control unit model SPM#.

The pseudo CPU model 131# may be designed to omit elements that are not required for logic verification such as a power source control circuit, a test circuit, a speed-up circuit. In addition, in the pseudo CPU model 131#, when the CPU core model 171# is designed to omit elements such a calculator and a register, the CPU core model 171# may be simplified in comparison with an actual CPU 11#. In addition, cache models of the multiple CPU core model 171# are integrated as the cache model 173#, thereby reducing an amount of circuits required for logic verification.

(An Exemplary Pseudo Main Memory Model 132#)

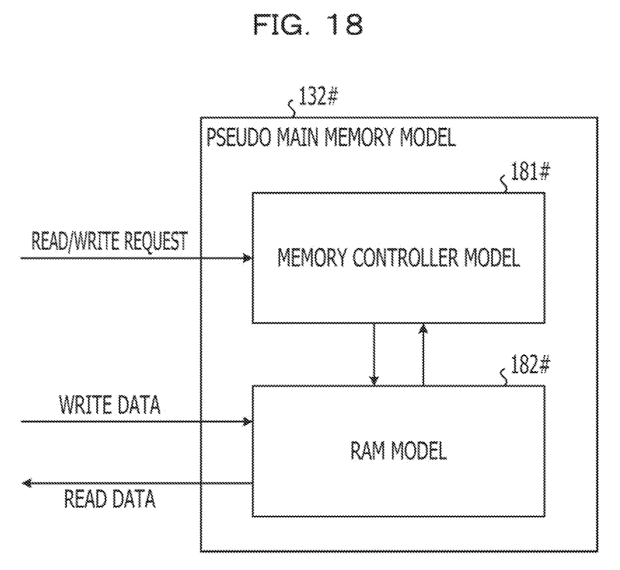

FIG. 18 illustrates an exemplary pseudo main memory model 132#. In FIG. 18, the pseudo main memory model 132# includes a memory controller model 181# and a RAM model 182#. The pseudo main memory model 132# is designed to integrate the functions of the main memory control unit 73# in the system controller 71# illustrated in FIG. 7.

The memory controller model 181# receives a read/write request with respect to the RAM model 182# through the pseudo priority control unit model SPM# and performs read/write with respect to the RAM model 182#.

The pseudo main memory model 132# may be designed to omit elements that are not required for logic verification such as a power source control circuit, a test circuit, and a DIIM controller function. In addition, when storage capacity in the pseudo main memory model 132# is limited to minimum capacity required for logic verification, the pseudo main memory model 132# may be simplified in comparison with the actual main memory 12#, thereby reducing an amount of circuits required for logic verification.

(An Exemplary Pseudo I/O Model 134#)

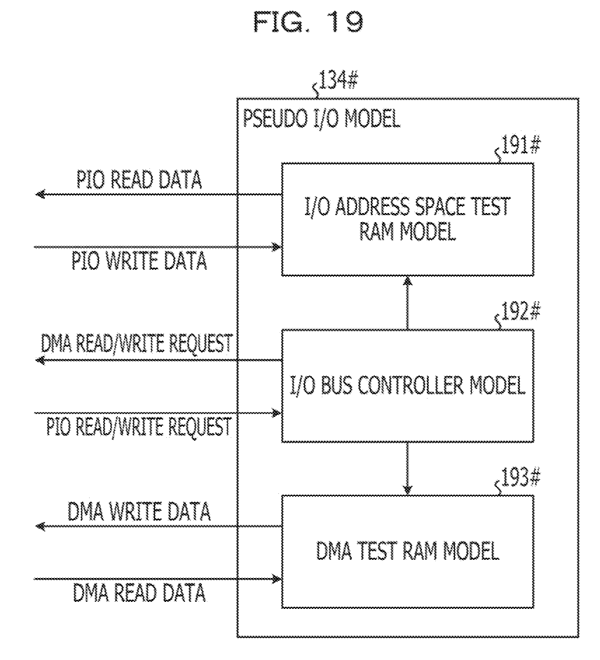

FIG. 19 illustrates an exemplary pseudo I/O model. In FIG. 19, the pseudo I/O model 134# includes an I/O address space test RAM model 191#, an I/O bus controller model 192#, and a direct memory access (DMA) test RAM model 193#.

The pseudo I/O model 134# is designed to integrate the functions of the I/O control unit 75# in the system controller 71# illustrated in FIG. 7. The I/O bus controller model 192# generates a DMA read/write request outputs the DMA read/write request to the pseudo priority control unit model SPM# as a memory request.

In addition, the I/O bus controller model 192# receives a programmed I/O (PIO) read/write request through the pseudo priority control unit model SPM#. In addition, the I/O bus controller model 192# reads PIO read data from the I/O address space test RAM model 191# and writes PIO write data to the I/O address space test RAM model 191#.

In addition, the I/O bus controller model 192# causes the DMA test RAM model 193# to output DMA write data and causes the DMA test RAM model 193# to input DMA read data after the DMA read data arrives. When elements that is not required for logic verification such as a power source control circuit, a test circuit, and a serial/parallel conversion circuit are omitted in the pseudo I/O model 134#, the pseudo I/O model 134# may be simplified in comparison with the actual I/O control unit 75#, thereby reducing an amount of circuits required for logic verification.

(A Modified Example of the Verification Target Circuit)

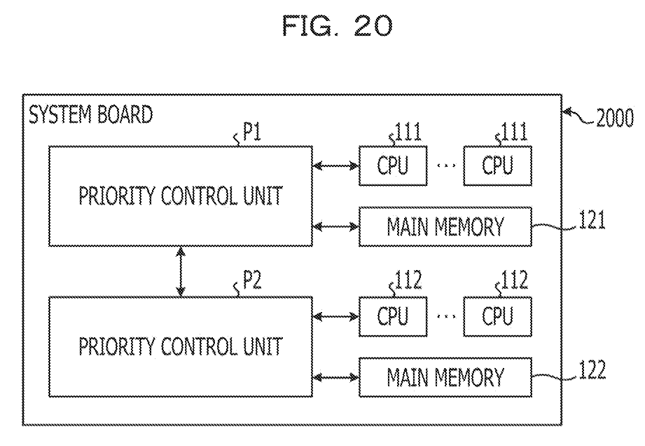

FIG. 20 illustrates a modified example of the verification target circuit according to the second embodiment. In FIG. 20, a system board 2000 includes priority control units P1 and P2, multiple CPU 111, multiple CPU 112, and main memories 121, 122. The system board 2000 may be an SMP system that including the priority control units P1 and P2 operating in synchronization with each other on a physically single substrate without the crossbar switch B.

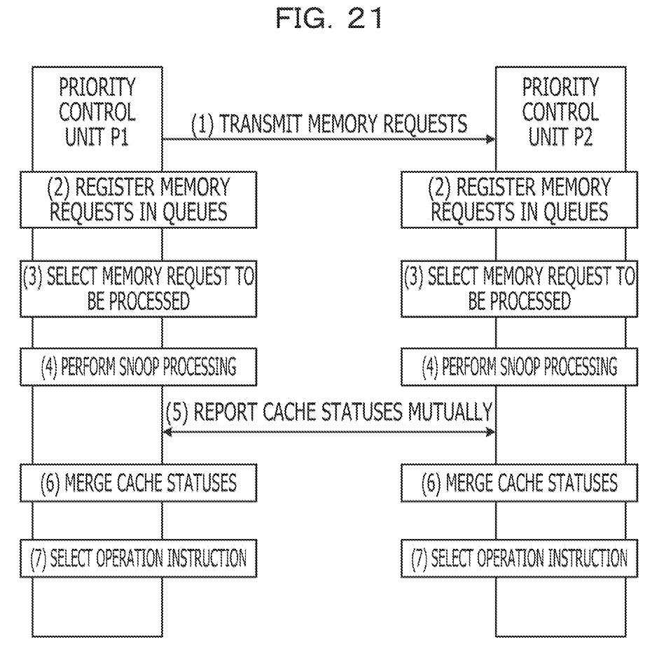

FIG. 21 illustrates another exemplary operation in the SMP system according to the second embodiment. A case where the priority control unit P1 in the system board 2000 issues memory request is described below. When operations of (2) to (7) that are described below are performed, the priority control units P1 and P2 operate in synchronization with each other.

In FIG. 21, (1) the priority control unit P1 transmits memory requests to the priority control unit P2.

(2) Each of the priority control units P1 and P2 registers the memory requests in the queues.

(3) Each of the priority control units P1 and P2 selects a memory request to be processed from the memory requests registered in the queues.

(4) Each of the priority control units P1 and P2 performs snoop processing for the selected memory request.

(5) The priority control units P1 and P2 mutually report cache statuses of the CPU 111 and 112.

(6) Each of the priority control units P1 and P2 merges the cache statuses of the CPU 111 and 112.

(7) Each of the priority control units P1 and P2 selects an operation instruction based on the merged cache statuses of the CPU 111 and 112.

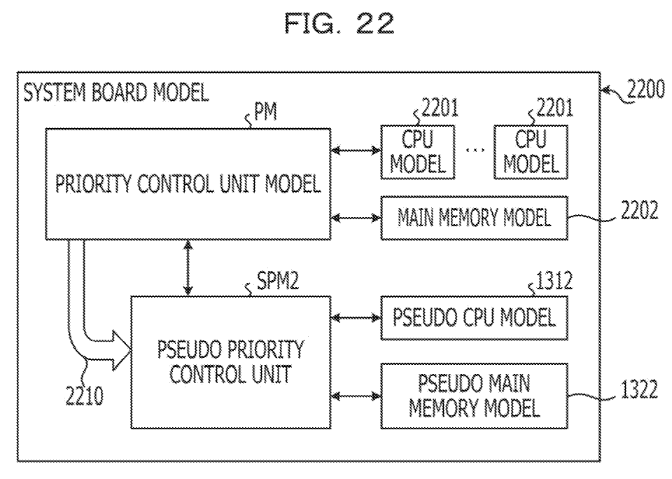

FIG. 22 illustrates a modified example of the verification model of the verification target circuit according to the second embodiment. In FIG. 22, a system board model 2200 corresponds to a verification model of the system board 2000. The system board model 2200 includes a priority control unit model PM, a pseudo priority control unit model SPM2, multiple CPU models 2201, a main memory model 2202, a pseudo CPU model 1312, and a pseudo main memory model 1322.

In the system board model 2200, the priority control unit model PM is coupled to the pseudo priority control unit model SPM2 through a signal line 2210 for logic verification. Multiple logic circuits including the priority control unit P# are built into the same LSI (physical chip), and the multiple logic circuits may be coupled to each other using the signal line 2210 even when there is a long distance between the multiple logic circuits and it is hard to couple the multiple logic circuits directly in an actual circuit.

As described above, in the verification model 1200 according to the second embodiment, the priority control unit model PM may report a memory request to the pseudo system board models SSM2 to SSMn through the signal line 1210 on the verification model 1200. Thus, the functions of the priority control units P1 to Pn where a memory request to be processed is selected with respect to each of the system boards S1 to Sn may be integrated, thereby reducing an amount of circuits required for logic verification in the verification model 1200. For example, in logic verification of a large-scale system including N system boards S1 to Sn, an amount of circuits in models for the priority control units P1 to Pn may be reduced by a factor of N.

In addition, in the verification model 1200, each of the pseudo priority control unit models SPM2 to SPMn may receive a memory request from the priority control unit model PM through the signal line 1210. As a result, each of the pseudo priority control unit models SPM2 to SPMn may perform snoop operations without queues.

In addition, in the verification model 1200, each of the pseudo priority control unit models SPM2 to SPMn may receive a cache status of the whole system from the priority control unit model PM through the signal line 1210. As a result, each of the pseudo priority control unit models SPM2 to SPMn may select an operation instruction to each of the units without middle stages corresponding to the stages s3 to s6 of the snoop pipeline model 1510.

In addition, in the verification model 1200, outputs of a sequential circuit operating in synchronization with a clock are divided from the system board model SM into the pseudo system board models SSM#, and the divided outputs are coupled to each of the pseudo system board models SSM#, thereby operating the pseudo system board models SSM# with an accuracy of the clock level.

In addition, in the verification model 1200, the configuration of the system boards S2 to Sn that are not regarded as verification targets is simplified and then modeled, thereby reducing an amount of circuits required for logic verification in the verification model 1200. For example, the pseudo CPU model 131#, the pseudo main memory model 132#, and the pseudo I/O model 134# are simplified in comparison with the actual CPU 11#, the actual main memory 12#, and the actual I/O control unit 75#, thereby reducing an amount of circuits required for logic verification in the verification model 1200.

Thus, in the verification support program, the logic verification device, and verification support method according to the embodiments, a verification model of a large server system is configured on a calculation system, thereby performing logic verification for a large system with an accuracy of the clock level. For example, the above-described verification model is mounted on a simulator, and then a verification operation such as application of test pattern or run of a test program is performed, thereby desirably performing logic verification for a large-scale system with an accuracy of the clock level.

The verification support method according to the embodiments may be realized by executing a previously prepared program in a computer such as a personal computer or a workstation. The verification support program according to the embodiments configured to be stored in a computer-readable recording medium such as a hardware disk, a flexible disk, a Compact Disc Read Only Memory (CD-ROM), a Magneto Optical Disc (MO), or a Digital Versatile Disc (DVD) may be executed when a computer reads the verification support program from the recording medium. In addition, the verification support program may be distributed through a network such as the Internet and downloaded to computers.

Although the embodiments of the present invention are numbered with, for example, “first,” “second,” or “third,” the ordinal numbers do not imply priorities of the embodiment. Many other variations and modifications will be apparent to those skilled in the art.

All examples and conditional language recited herein are intended for pedagogical purposes to aid the reader in understanding the aspects of the invention and the concepts contributed by the inventor to furthering the art, and are to be construed as being without limitation to such specifically recited examples and conditions, nor does the organization of such examples in the specification relate to a showing of the superiority and inferiority of the aspects of the invention. Although the embodiment in accordance with aspects of the present invention has been described in detail, it should be understood that various changes, substitutions, and alterations could be made hereto without departing from the spirit and scope of the invention.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A non-transitory computer-readable recording medium configured to store a verification support program, the program causing a computer to execute logic verification operations for a system including a plurality of control circuits that have circuit configurations equivalent to each other and operate in synchronization with each other, and a plurality of hardware units that correspond to the control circuits and process a same instruction, the logic verification operations being executed using a verification model of the system, the verification model including a control circuit model obtained by modeling a function of one of the plurality of control circuits, and a plurality of hardware models obtained by modeling functions of the plurality of hardware units, the logic verification operations comprising:
causing the control circuit model to accept instructions from the plurality of hardware models;
causing the control circuit model to select an instruction to be processed by one of the plurality of hardware models from the accepted instructions; and
causing the control circuit model to report a processing request of the selected instruction to the plurality of hardware models.

2. The non-transitory computer-readable recording medium according to claim 1, wherein
each of the plurality of hardware models includes a central processing unit (CPU) model obtained by modeling a function of a CPU in the hardware and includes a main memory model obtained by modeling a function of a main memory in the hardware,
the reporting operation includes a first reporting operation including:
causing the control circuit model to report a snoop request for inquiring whether or not the CPU model in each of the hardware models caches data stored in the main memory models included in the verification model, to the plurality of hardware models.

3. The non-transitory computer-readable recording medium according to claim 2, wherein
the reporting operation further includes a second reporting operation including:
causing the control circuit model to report a snoop response of each of the hardware models obtained after the snoop request is reported in the first reporting operation, to the plurality of hardware models.

4. The non-transitory computer-readable recording medium according to claim 2, wherein
in the first reporting operation, the control circuit model reports the snoop request to the plurality of hardware models using a signal line that is used for logic verification and directly couples the control circuit model to the plurality of hardware models.

5. The non-transitory computer-readable recording medium according to claim 2, wherein
in the second reporting operation, the control circuit model reports the snoop response to the plurality of hardware models using the signal line that is used for logic verification and directly couples the control circuit model to the plurality of hardware models.

6. The non-transitory computer-readable recording medium according to claim 1, wherein
a verification target of the verification model is a hardware model obtained by modeling a function of hardware directly coupled to one of the control circuits from among the plurality of hardware models.

7. The non-transitory computer-readable recording medium according to claim 1, wherein
the verification model is described at a register transfer level.

8. The non-transitory computer-readable recording medium according to claim 1, wherein
the verification model is described at a gate level.

9. A logic verification device to perform logic verification operations for a system including a plurality of control circuits that have circuit configurations equivalent to each other and operate in synchronization with each other, and a plurality of hardware units that correspond to the control circuits and process a same instruction, the logic verification device comprising:
an acceptance unit in which a control circuit model obtained by modeling a function of one of the plurality of control circuits accepts instructions from a plurality of hardware models obtained by modeling functions of the plurality of hardware units;
a selection unit in which the control circuit model selects an instruction to be processed by one of the plurality of hardware models from the accepted instructions; and
a report unit in which the control circuit model reports a processing request of the selected instruction to the plurality of hardware models.

10. A verification support method of performing logic verification operations for a system including a plurality of control circuits that have circuit configurations equivalent to each other and operate in synchronization with each other, and a plurality of hardware units that correspond to the control circuits and process a same instruction, the logic verification operations being performed using a verification model of the system, the verification model including a control circuit model obtained by modeling a function of one of the plurality of control circuits and a plurality of hardware models obtained by modeling functions of the plurality of hardware units, the verification support method comprising:
causing the control circuit model to accept instructions from the plurality of hardware models;
causing the control circuit model to select an instruction to be processed by one of the plurality of hardware models from the accepted instructions; and
causing the control circuit model to report a processing request of the selected instruction to the plurality of hardware models.
